(19) United States
(12) Patent Application Publication
(10) Pub. No.: US 2025/0200615 A1
(43) Pub. Date: Jun. 19, 2025

(54) SYSTEMS AND METHODS FOR AI-BASED GENERATION AND DELIVERY OF NETWORK RESOURCES

(71) Applicant: YAHOO ASSETS LLC, New York, NY (US)

(72) Inventor: Bishwajit AICH, Milpitas, CA (US)

(21) Appl. No.: 18/539,396

(22) Filed: Dec. 14, 2023

(51) Int. Cl. G06Q 30/0241; H04L 67/306

(52) U.S. Cl. CPC G06Q 30/0277; H04L 67/306

(57) ABSTRACT

Disclosed are systems and methods that provide a decision-intelligence (DI)-based, computerized framework for performing contextual mapping between hosted and provided content, from which curated digital content and/or associated content campaigns can be implemented. The disclosed framework can be implemented by supply-side platforms (SSPs), demand-side platforms (DSPs) and/or content delivery platforms (CDPs), which can leverage the contextual mapping and content curation tools provided by the disclosed framework to effectively plan, launch, optimize and monitor the performance of content campaigns implemented over a network on network resources. The disclosed strategic and data-driven processes rendered capably by the disclosed framework for SSP and/or DSP initiatives can define campaign parameters, and in real-time, monitor the effectiveness of campaigns such that their modifications and/or alterations can be dynamically performed so as to adapt to the changing landscapes of how the campaign is being disseminated over a network and received by users.

### FIELD OF THE DISCLOSURE

The present disclosure is generally related to content extraction, generation and delivery, and more particularly, to a decision intelligence (DI)-based computerized framework for deterministically performing contextual mapping between hosted and provided content, from which curated digital content and/or associated content campaigns can be implemented.

### SUMMARY OF THE DISCLOSURE

According to some embodiments, the disclosed systems and methods provide novel artificial intelligence (AI)-based mechanisms for supply-side platforms (SSPs) and/or demand-side platforms (DSPs) to effectively plan, launch, optimize and monitor the performance of content campaigns. As discussed herein, the disclosed systems and methods are realized via a provided computerized framework that operates to perform strategic and data-driven processes for SSP and DSP initiatives. Accordingly, in some embodiments, the SSP and DSP can be associated with and/or part of a content delivery platform (CDP) (e.g., Yahoo!®).

According to some embodiments, the disclosed contextual content curation and dissemination framework can leverage artificial intelligence/machine learning (AI/ML), and natural language processing (NLP) techniques to dynamically interpret how to render electronic resources (e.g., webpages, websites, applications, and the like; also referred to as “network resources,” used interchangeably). In some embodiments, the disclosed framework can determine and leverage the context of available digital content items (e.g., digital advertisements), such that a comparison and/or contextual analysis of the resource and sentiment of the potential digital content item(s) can be performed, resulting in a determination of the most contextually appropriate form, format and/or causation for display. According to some embodiments, such computerized processing can be facilitated in real-time, at runtime of the rendering of a resource (e.g., launching a webpage, for example), thereby allowing for dynamic optimization and continuous learning based on user interactions. Indeed, as evidenced from the instant disclosure's technical aspects, programmatic content dissemination may involve real-time bidding (RTB), where AI/ML algorithms can participate in auctions to secure ad spaces, ensuring a seamless and contextually aligned CDP and user experience.

Conventional mechanisms for determining what content and/or whether to provide content in conjunction with a rendered electronic resource are static, and rely on predefined rules for analyzing titles and/or keywords of the electronic resources. However, this falls short of fully capturing the dynamic nature of how resources are requested and/or interacted with by users. The sentiment of the resource, intention of the user and/or the context of the resource must be accounted for, which is a feature, among others, that the disclosed framework determines and leverages for content recommendation, supplementation and dissemination over electronic networks, as discussed herein.

According to some embodiments, reference to a content campaign (e.g., advertising campaign), as discussed herein, involves a range of technical considerations. As determined, defined and/or controlled by CDPs, ad formats (e.g., display, video and/or native ads), ad channels, targeting parameters, target audience (e.g., demographics, interests, geographics, and the like), keyword optimization, tracking tools and analytics, budgeting and compliance, and the like, or some combination thereof, can be tailored to campaign objectives. Accordingly, the content campaign can correlate to and/or indicate a goal or an intent, which can be associated with a type of audience, an intended audience, and/or a time period, geographic area and/or form or type of content, among other parameters defined by the campaign.

Accordingly, in some embodiments, the disclosed framework can leverage a large language model (LLM) to seamlessly extract and leverage relevant information from electronic resources (e.g., websites, webpages, applications, portals, data repositories, a cloud, and the like). As discussed herein, implementation of an LLM (and/or any other form of AI/ML model) can generate extraction requests that can be dynamically executed and updated, which can enable the framework to “drill-down” on contextual and/or topical aspects of categories of data. This, as evidenced from the below discussion, can provide customized feature extraction mechanisms for CDPs to harness. Thus, rather than leveraging generic tools to obtain data about a topic or category (e.g., a taxonomy), the disclosed systems and methods provide novel technicality that can optimize how extractions can be performed, thereby increasing their accuracy and improving how efficiently CDPs can obtain the information being sought.

The latest versions of LLMs have, among other features and capabilities, theory of mind, abilities to reason, abilities to make a list of tasks, abilities to plan and react to changes (via reviewing their own previous decisions), abilities to understand multiple data sources (and types of data—multimodal), abilities to have conversations with humans in natural language, abilities to adjust, abilities to interact with and/or control application program interfaces (APIs), abilities to remember information long term, abilities to use tools (e.g., read multiple schedules/calendars, command other systems, search for data, and the like), abilities to use other LLM and other types of AI/ML (e.g., neural networks to look for patterns, recognize humans, pets, and the like, for example), abilities to improve itself, abilities to correct mistakes and learn using reflection, and the like.

Thus, as provided herein, the disclosed integration of such LLM technology, as well as known or to be known AI/ML models, to execute the disclosed content generation and delivery mechanisms discussed herein provides an improved system that can enable the creation of new ways of serving digital content, while reaching an expanded set of users, inter alia.

According to some embodiments, a method is disclosed for a DI-based computerized framework for deterministic bb ally performing contextual mapping between hosted and provided content, from which curated digital content and/or associated content campaigns can be implemented. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for deterministically performing contextual mapping between hosted and provided content, from which curated digital content and/or associated content campaigns can be implemented.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIGS. 3A-3B illustrate exemplary workflows according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

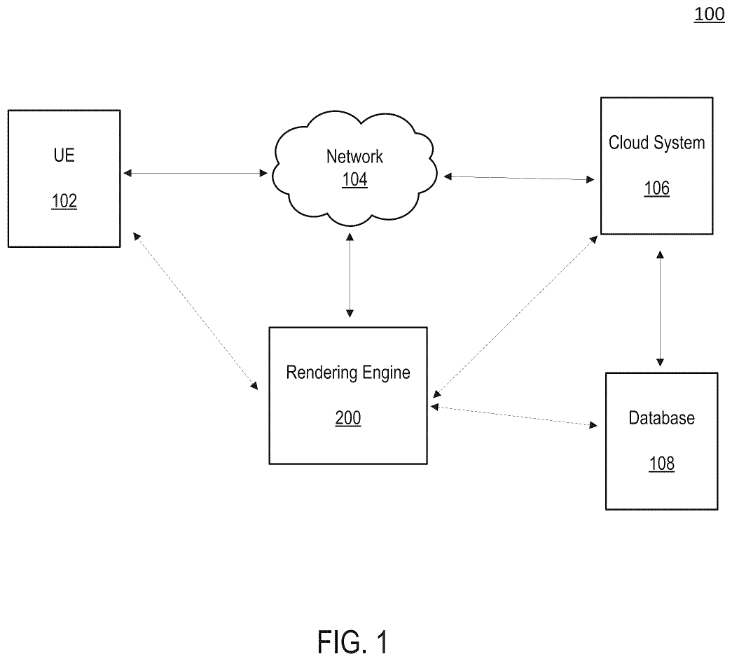

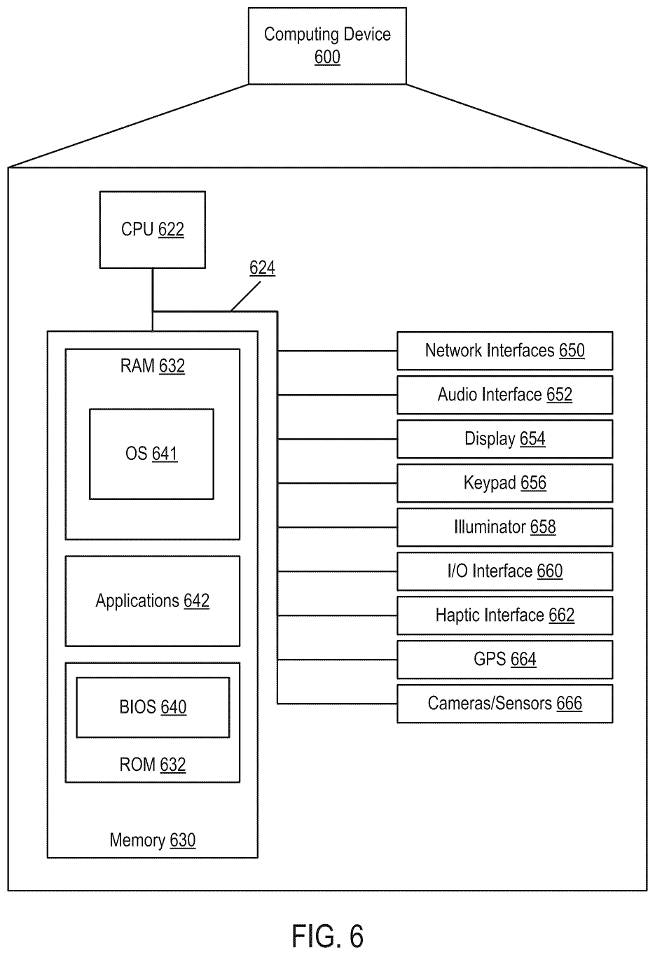

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and rendering engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver. For example, UE 102 can be associated with a device on network 104, which is performing operations for generating and communicating an ad campaign, inclusive of the digital objects that make up the campaign, that will be delivered to other UEs on the network.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network platform (e.g., Yahoo!®), which has associated network resources hosted on the internet or private network (e.g., network 104), which enables (via engine 200) the campaign management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or rendering engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

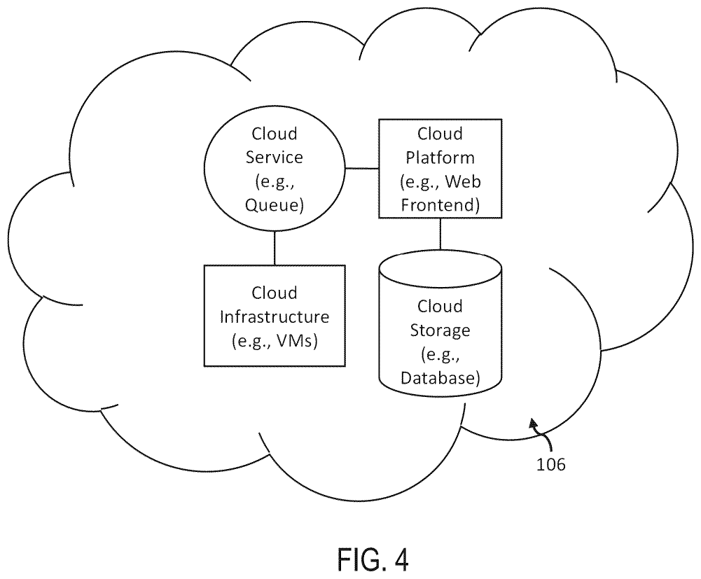

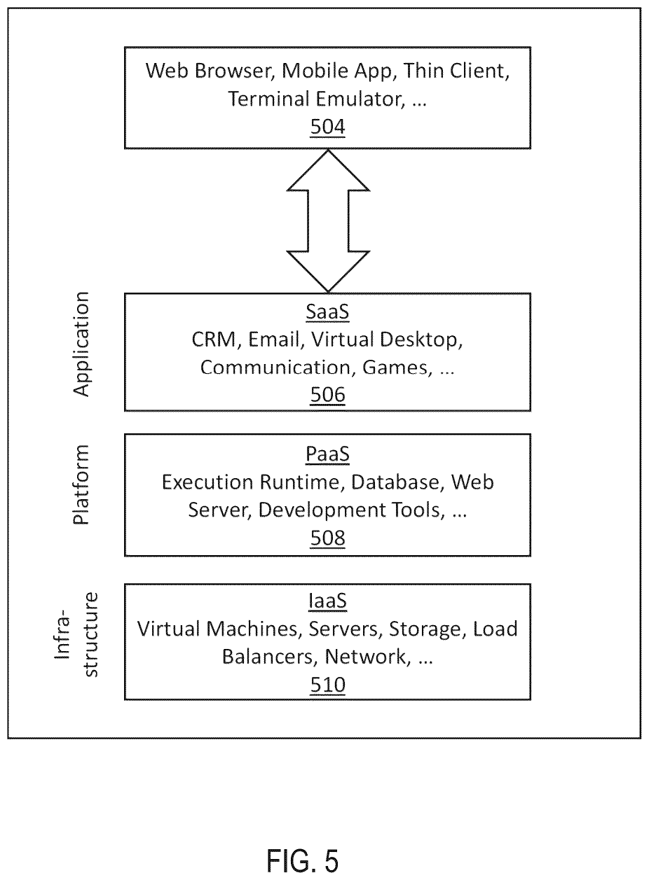

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Rendering engine 200, as discussed above and further below in more detail, can include components for the disclosed functionality. According to some embodiments, rendering engine 200 may be a special purpose machine or processor, and can be hosted by a device on network 104, within cloud system 106, and/or on UE 102. In some embodiments, engine 200 may be hosted by a server and/or set of servers associated with cloud system 106.

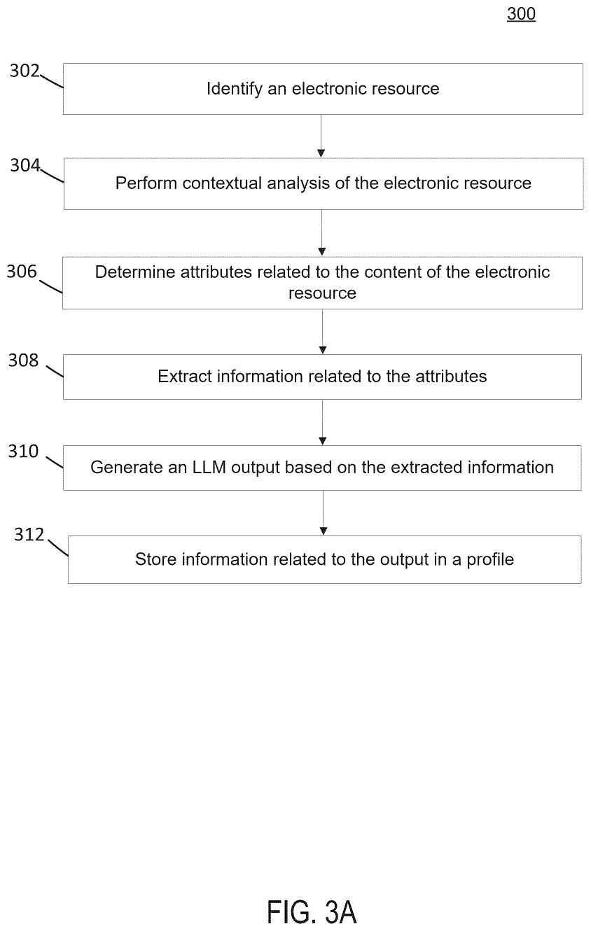

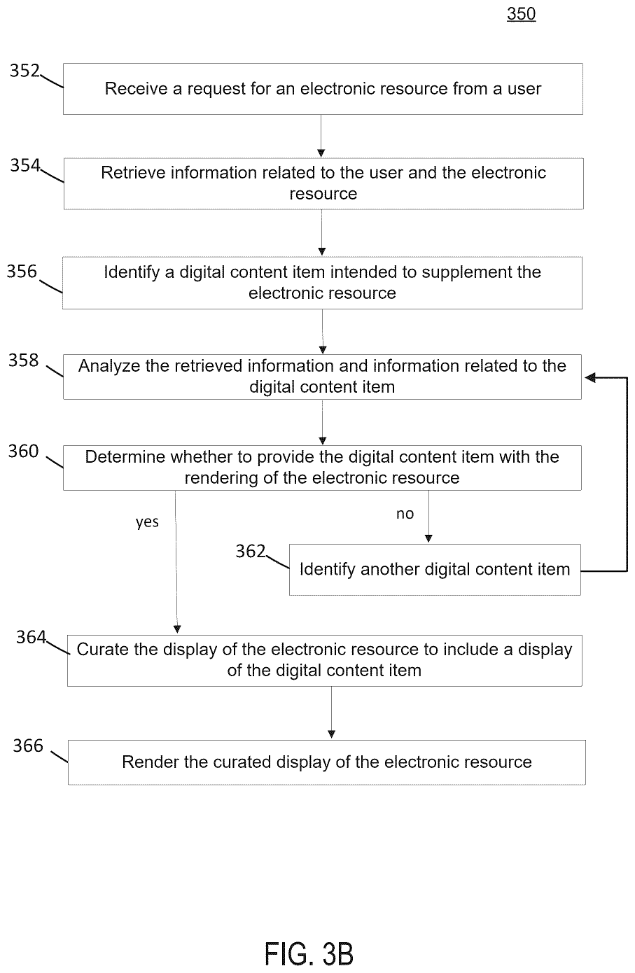

According to some embodiments, as discussed in more detail below, rendering engine 200 may be configured to implement and/or control a plurality of services and/or microservices, where each of the plurality of services/microservices are configured to execute a plurality of workflows associated with performing the disclosed campaign management. Non-limiting embodiments of such workflows are provided below in relation to at least FIGS. 3A-3B.

According to some embodiments, as discussed above, rendering engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

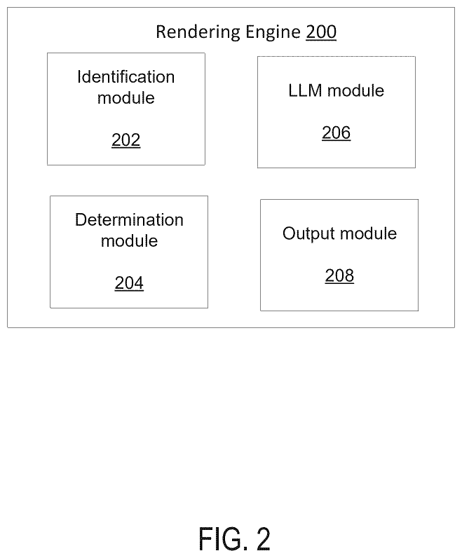

As illustrated in FIG. 2, according to some embodiments, rendering engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3A, Process 300 provides non-limiting example embodiments for the disclosed content generation and delivery framework. As provided below, the disclosed framework's configuration and implementation can provide a computerized suite of SSP and DSP tools for managing content (e.g., advertisement) campaigns and the digital content included therein.

According to some embodiments, as discussed herein, at least respective to the steps for Process 300 and 350 of FIGS. 3A and 3B, respectively, AI/ML techniques can play a pivotal role in assessing the sentiment (and context) of electronic resources (e.g., webpages) and the context conveyed by digital content items (e.g., advertisements) to ascertain the most suitable match. According to some embodiments, as discussed herein, this can involve employing LLMs to comprehend the context and meaning embedded in the textual content of electronic resources, identifying key topics, keywords and sentiments.

For example, in some embodiments, for resources featuring rich media content, AI/ML models can utilize computer vision techniques to analyze images and videos, extracting contextual information.

In some embodiments, the context of digital content item (e.g., advertisement), whether derived from text or visual elements, can then be analyzed. In some embodiments, as discussed below, a matching algorithm(s) can be employed to compare the sentiment (and/or contextual) analysis of the electronic resource with the context of available digital content item(s), considering factors such as, but not limited to, keyword relevance and sentiment alignment.

Accordingly, as discussed below, the disclosed framework can then leverage AI/ML computations to perform decisions on optimal ad placements, favoring content items whose context align with the sentiment of the webpage. In some embodiments, such decisions can involve deciding not to place an ad on a resource at all, given the conflicting sentiment of the resource (e.g., a webpage with reviews for a vehicle that are negative, for example).

Thus, the disclosed multifaceted approach to content placement with and/or within electronic resources can enhance the accuracy and efficiency of ad selection and placement, contributing to a more contextually relevant and effective advertising experience for users.

According to some embodiments, Step 302 of Process 300 can be performed by identification module 202 of rendering engine 200; Steps 304-308 can be performed by determination module 204; Step 310 can be performed by LLM module 206; and Step 312 can be performed by output module 208.

According to some embodiments, Process 300 begins with Step 302 where engine 200 can identify an electronic resource. As discussed above, an electronic resource can include, but is not limited to, a webpage, website, application (e.g., a user interface (UI) page of a displayed application), cloud, and the like. For example, an electronic resource can be any type of electronic file, document, item, location and the like that is capable of being displayed and/or accessed by a user for which supplemental digital content can then be displayed or served to a viewing/accessing user.

In Step 304, engine 200 can perform contextual analysis of the electronic resource. Such analysis can involve parsing, and determining, deriving or otherwise identifying information related to, but not limited to, the content of the resource, data/metadata of the resource, structure of the resource, format of the resource, type of the resource, source of the resource, location of the resource, and the like, or some combination thereof.

According to some embodiments, Step 304 can involve engine 200 analyzing the electronic resource by engine 200 executing a specific trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may leverage an LLM, whether known or to be known. As discussed above, an LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Thus, in Step 306, based on the analysis of the electronic, engine 200 can determine attributes related to the content of the electronic resource. As above, such attributes can indicate, but are not limited to, type, format and/or quality of the content, data/metadata of the resource, structure of the resource, format of the resource, type of the resource, source of the resource, location of the resource, and the like, or some combination thereof. In some embodiments, information related to the determined attributes can be stored in database 108, as discussed above.

In Step 308, engine 200 can then extract the information related to the attributes. In some embodiments, such extraction can be performed via any of the above mentioned AI/ML and/or LLM techniques. In some embodiments, for example, for webpages, engine 200 can perform Hypertext Markup Language (HTML) parsing, Document Object Model (DOM) traversal, Cascading Style Sheets (CSS) selectors or XML Path Language (XPath) parsing, and the like, or some combination thereof.

Accordingly, as a result of Steps 306 and 308, engine 200 can have compiled a set of information related to the context of the electronic resource, as provided by the extracted attribute information. As above, such information can be stored in database 108.

In Step 310, engine 200 can input the compiled set of information related to the context of the electronic resource (e.g., “context information”) to an LLM(s). In some embodiments, such inputting can involve, but is not limited to, performing NLP processing in the context information, such that text (or a character string) is generated related to the context information, which can be input to an LLM prompt.

In some embodiments, the LLM can be executed, for which an LLM output can be generated that is based on the input context information. According to some embodiments, the LLM output can provide information related to the extracted information, but not limited to, a context, style, tone, sentiment, predicted effectiveness of the content, and the like.

And, in Step 312, engine 200 can store the information related to the above processing of Process 300 in a profile. In some embodiments, the profile can correspond to, but not be limited to, a user, advertiser, SSP, DSP, CDP, electronic resource, digital content item(s) (e.g., advertisement(s)), and the like, or some combination thereof. In some embodiments, the profile (or profiles) can include information related to, but not limited to, the determined attributes, extracted information and/or LLM output. For example, the LLM output can be stored in a profile for the electronic resource. Therefore, the profile(s) can include data related to taxonomies about the resource, ads, users, CDPs (e.g., SSP and/or DSP), and the like, or some combination thereof.

Turning to FIG. 3B, Process 350 leverages utilizing the stored and learned information from Process 300 for purposes of providing digital content to users interacting with electronic resources (e.g., traversing the Internet and accessing a webpage, for example).

According to some embodiments, Steps 352-356 of Process 350 can be performed by identification module 202 of rendering engine 200; Steps 358 and 360 can be performed by determination module 204; and Steps 362-366 can be performed by output module 208.

According to some embodiments, Process 350 begins with Step 352 where a request for an electronic resource is received. According to some embodiments, such request can correspond to a user, via their device, navigating the Internet to a specific webpage, for example.

In Step 354, engine 200 can retrieve information related to the user (and/or the user device) and the electronic resource. In some embodiments, the retrieval of user information can correspond to, but not be limited to, user identifier (ID), device ID, location, time, date, and/or user profile information, which can provide information related to the user's behavior, demographics, biometrics and the like. Thus, for example, a profile for the user can be identified and mined for data about the user. In some embodiments, retrieval of the electronic resource information can correspond to the profile of the electronic resource (e.g., as per Step 312, supra). In some embodiments, the electronic resource can be analyzed, for which data/metadata of the resource can be retrieved. In some embodiments, the processing of Process 300 can be performed for requested resources, which can be based on, but not limited to, (triggered via) the request, a time since a last profile was generated or updated, the resource not having a profile, and the like.

In Step 356, engine 200 can identify a digital content item for supplementation of the rendering of the electronic resource (e.g., display of a webpage). In some embodiments, engine 200 can leverage a context of the electronic resource (e.g., as identified in Step 354) and search a content repository, for which a content item(s) is identified and retrieved. Such retrieval can be based on a query that identifies the content items with content that corresponds to the context of the electronic resource (e.g., a webpage about Minivans, and an advertisement that provides incentives for purchasing a car, for example).

In Step 358, engine 200 can analyze the retrieved information (from Step 354) and the information related to the digital content item (from Step 356). According to some embodiments, such analysis can be performed via any of the AI/ML and/or LLM techniques discussed above (e.g., contextual and/or sentimental analysis via AI/ML and/or LLM models, supra).

In Step 360, as a result of the analysis of Step 358, engine 200 can determine whether to provide the digital content item with the rendering of the electronic resource. As discussed above, such determination corresponds to determining whether the context of the digital content item supports, advocates and/or matches to the sentiment of the electronic resource.

By way of a non-limiting example, if the electronic resource is a webpage about Minivan reviews, and the content item is an advertisement for such cars, engine 200 can determine whether the context of the content item aligns with the sentiment of the Minivan website. For example, if the website's sentiment (or narrative) is disparaging Minivans in lieu of SUVs, placement of the ad on that page would be improper. In another example, if the sentiment of the Minivan website is that Minivans are lower-priced alternatives to SUVs, then ads with discounts for Minivans may also be improper, as ads for upgrades to such vehicles may be better suited.

Thus, in some embodiments, when engine 200 determines that the context of the content item does not match the sentiment of the electronic resource (to at least a threshold similarity value), as in Step 360, processing can proceed to Step 362. In Step 362, engine 200 can proceed to identifying another digital content item, which can be performed in a similar manner as discussed above in Step 356, with an additional factor that considers that the previously identified content item did not align with the electronic resource's sentiment. Thus, the search for an additional content item can be further based on information, as included in a query of the content repository, related to, but not limited to, the sentiment (and context) of the electronic resource, context of the content item (identified in Step 356) and the determination from Step 360. Accordingly, engine 200 can recursively proceed to Step 358 to perform the analysis of Step 358 and determination of Step 360, as discussed supra.

In some embodiments, when the determination in Step 360 results in a determination that the context of the digital content item aligns (at least a threshold similarity value) with the sentiment of the electronic resource, engine 200 proceeds to Step 364.

In Step 364, engine 200 can curate the display (e.g., UI) of the electronic resource to include a display of the digital content item. Such curation can be based on, but not limited, parameters provided by the SSP, parameters provided by the DSP, parameters provided by the CDP, formatting and/or display parameters of the content item and/or resource, display capabilities of the device of the user rendering the electronic resource, and the like, or some combination thereof. Thus, in some embodiments, Step 364 can involve the modification of the electronic resource (e.g., for example, the DOM of a webpage can be modified to ensure proper display of an animated media advertisement).

And, in Step 366, engine 200 can cause, facilitate and/or enable the rendering of the curated display of the electronic resource on the device of the user, which can be in direct response to the request from the user. Thus, in some embodiments, the processing of Process 350 can be performed at runtime, dynamically and automatically in response to a request for an electronic resource.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
receiving, over a network, a request from a device of a user, the request identifying an electronic resource, the electronic resource comprising information corresponding to a sentiment of content of the electronic resource;
identifying, based at least one the electronic resource, a digital content item, the digital content item comprising information corresponding to a context of content of the digital content item;
analyzing, via a machine learning (ML) model, the information related to the electronic resource and the information related to the digital content item;
determining, based on the ML model analysis, a correlation between the electronic resource and the digital content item, the correlation providing an indication of a similarity between the sentiment of the electronic resource and the context of the digital content item;
curating, based on the determined correlation, a user interface (UI) for the electronic resource, the curation comprising modifying a structure and content of the electronic resource based on the digital content item; and
communicating, over the network, for display on a display of the device of the user, the curated UI of the electronic resource.

2. The method of claim 1, further comprising:
analyzing data and metadata related to the electronic resource;
determining, based on the analysis of the data and metadata, attributes related to the content of the electronic resource; and
extracting, based on the determined attributes, the information from the electronic resource.

3. The method of claim 2, further comprising:
analyzing, via a large language model (LLM), the extracted information;
determining, via the LLM, the sentiment of the content of the electronic content; and
storing the determined sentiment in a profile, wherein the analysis, via the ML model, is based on a retrieval of the stored sentiment from the profile.

4. The method of claim 1, wherein the determined correlation comprises an indication that the similarity between the sentiment and the context does not satisfy a similarity threshold.

5. The method of claim 4, further comprising:
identifying another digital content item; and
performing the determination of correlation for the other digital content item.

6. The method of claim 4, wherein the curation of the UI comprises a rendering of the electronic resource without the digital content item.

7. The method of claim 1, wherein the determined correlation comprises an indication that the similarity between the sentiment and the context does satisfy a similarity threshold, wherein curation of the UI comprises a rendering of the electronic resource with the digital content item, wherein the curation comprises modifying the electronic resource to include the digital content item.

8. The method of claim 1, further comprising:
searching a content repository based on a query defined at least by the sentiment of the content of the electronic resource; and
identifying, based on the search, the digital content item.

9. A system comprising:
a processor configured to:
receive, over a network, a request from a device of a user, the request identifying an electronic resource, the electronic resource comprising information corresponding to a sentiment of content of the electronic resource;
identify, based at least one the electronic resource, a digital content item, the digital content item comprising information corresponding to a context of content of the digital content item;
analyze, via a machine learning (ML) model, the information related to the electronic resource and the information related to the digital content item;
determine, based on the ML model analysis, a correlation between the electronic resource and the digital content item, the correlation providing an indication of a similarity between the sentiment of the electronic resource and the context of the digital content item;
curate, based on the determined correlation, a user interface (UI) for the electronic resource, the curation comprising modifying a structure and content of the electronic resource based on the digital content item; and
communicate, over the network, for display on a display of the device of the user, the curated UI of the electronic resource.

10. The system of claim 9, wherein the processor is further configured to:
analyze data and metadata related to the electronic resource;
determine, based on the analysis of the data and metadata, attributes related to the content of the electronic resource;
extract, based on the determined attributes, the information from the electronic resource;
analyze, via a large language model (LLM), the extracted information;
determine, via the LLM, the sentiment of the content of the electronic content; and
store the determined sentiment in a profile, wherein the analysis, via the ML model, is based on a retrieval of the stored sentiment from the profile.

11. The system of claim 9, wherein the determined correlation comprises an indication that the similarity between the sentiment and the context does not satisfy a similarity threshold.

12. The system of claim 11, wherein the processor is further configured to:
identifying another digital content item; and
performing the determination of correlation for the other digital content item.

13. The system of claim 11, wherein the curation of the UI comprises a rendering of the electronic resource without the digital content item.

14. The system of claim 9, wherein the determined correlation comprises an indication that the similarity between the sentiment and the context does satisfy a similarity threshold, wherein curation of the UI comprises a rendering of the electronic resource with the digital content item, wherein the curation comprises modifying the electronic resource to include the digital content item.

15. A non-transitory computer-readable storage medium tangibly encoded with computer-executable instructions that when executed by a processor, perform a method comprising:
receiving, over a network, a request from a device of a user, the request identifying an electronic resource, the electronic resource comprising information corresponding to a sentiment of content of the electronic resource;
identifying, based at least one the electronic resource, a digital content item, the digital content item comprising information corresponding to a context of content of the digital content item;
analyzing, via a machine learning (ML) model, the information related to the electronic resource and the information related to the digital content item;
determining, based on the ML model analysis, a correlation between the electronic resource and the digital content item, the correlation providing an indication of a similarity between the sentiment of the electronic resource and the context of the digital content item;
curating, based on the determined correlation, a user interface (UI) for the electronic resource, the curation comprising modifying a structure and content of the electronic resource based on the digital content item; and
communicating, over the network, for display on a display of the device of the user, the curated UI of the electronic resource.

16. The non-transitory computer-readable storage medium of claim 15, further comprising:
analyzing data and metadata related to the electronic resource;
determining, based on the analysis of the data and metadata, attributes related to the content of the electronic resource;
extracting, based on the determined attributes, the information from the electronic resource;
analyzing, via a large language model (LLM), the extracted information;
determining, via the LLM, the sentiment of the content of the electronic content; and
storing the determined sentiment in a profile, wherein the analysis, via the ML model, is based on a retrieval of the stored sentiment from the profile.

17. The non-transitory computer-readable storage medium of claim 15, wherein the determined correlation comprises an indication that the similarity between the sentiment and the context does not satisfy a similarity threshold.

18. The non-transitory computer-readable storage medium of claim 17, further comprising:
identifying another digital content item; and
performing the determination of correlation for the other digital content item.

19. The non-transitory computer-readable storage medium of claim 17, wherein the curation of the UI comprises a rendering of the electronic resource without the digital content item.

20. The non-transitory computer-readable storage medium of claim 15, wherein the determined correlation comprises an indication that the similarity between the sentiment and the context does satisfy a similarity threshold, wherein curation of the UI comprises a rendering of the electronic resource with the digital content item, wherein the curation comprises modifying the electronic resource to include the digital content item.
